(19) United States
(12) Patent Application Publication
(10) Pub. No.: US 2020/0376529 A1
(43) Pub. Date: Dec. 3, 2020

(54) EXTRUSION OF METAL MATERIAL USING A DUMMY BLOCK HAVING A CURVED SURFACE

(71) Applicant: The Regents of the University of Michigan, Ann Arbor, MI (US)

(72) Inventor: Daniel Ross Cooper, Ann Arbor, MI (US)

(21) Appl. No.: 16/766,347

(22) PCT Filed: Nov. 18, 2019
(86) PCT No.: PCT/US2019/061999

§ 371 Date: May 22, 2020

Related U.S. Application Data
(60) Provisional application No. 62/766,607, filed on Nov. 15, 2018.

(51) Int. Cl. B21C 26/00; B21C 23/00; B23K 20/12

(52) U.S. Cl. CPC B21C 26/00; B23K 20/12; B21C 23/00

(57) ABSTRACT

Various embodiments provide for an extrusion device with a dummy block having a curved surface configured to change the shape and length of charge welds between extrudates originating from different billets in order to reduce the amount of scrap and waste material. In an embodiment, the dummy block, which forces the billet of material through the die, can have a concave front surface such that the material, as it is extruded through the die, forms a solid-state weld that is shorter than a flat faced dummy block. In another embodiment, the dummy block can have a convex front surface such that the material, as it is extruded through the die, forms a solid-state weld that is longer than a weld due to a flat faced dummy block. In other embodiments, billets with non-flat ends can also be used.

### CROSS-REFERENCE TO RELATED APPLICATIONS

This application is a Non-Provisional of U.S. Provisional Application No. 62/766,607, filed on 15 Nov. 2018, the entire contents of which are incorporated herein by reference.

### TECHNICAL FIELD

The subject disclosure relates to an extrusion device using an ogive-shaped dummy block to reduce an amount of wasted extruded material.

### BACKGROUND

Metal extrusion is a metal forming process in which a billet of a certain length and cross section, is forced to flow through a die of a smaller cross-sectional area, thus forming the billet to the new cross section. The length of the extruded part will vary, dependent upon the amount of material in the work piece and the profile extruded. Numerous cross sections are manufactured by this method. The cross section produced will be uniform over the entire length of the metal extrusion. Starting work is usually a cylindrical billet, although other shapes are also possible, which may be formed into a round part of smaller diameter, a hollow tube, or some other profile.

### SUMMARY

The following presents a simplified summary of the specification to provide a basic understanding of some aspects of the specification. This summary is not an extensive overview of the specification. It is intended to neither identify key or critical elements of the specification nor delineate any scope particular to any embodiments of the specification, or any scope of the claims. Its sole purpose is to present some concepts of the specification in a simplified form as a prelude to the more detailed description that is presented later.

In a non-limiting example, an extrusion device can comprise an extrusion chamber and an extrusion die with an opening configured to receive a billet of material from the extrusion chamber into the extrusion die. The device can also include a dummy block configured to push a first billet of material through the opening of the extrusion die resulting in first extruded material, wherein a surface of the dummy block that is in contact with the first billet of material is a curved surface. In one or more embodiments, the curved surface is an ogive shaped surface.

In another non-limiting example, an extrusion device can comprise an extrusion chamber and an extrusion die with an opening through which a billet of material is extruded. The extrusion device can also comprise a dummy block configured to push a first billet of material from the extrusion chamber and through the opening of the die resulting in first extruded material, wherein a surface of the dummy block that is in contact with the first billet of material is a non-flat surface. In some embodiments, the non-flat surface has a curvature. In at least one embodiment, the curvature is an ogive shaped curvature.

In another non-limiting example, a method can include extruding, by a first dummy block with a shaped front end, a billet of material through a die opening to form first extruded material. The method can also include forming a first charge weld between the first extruded material and second extruded material extruded before the first extruded material. In an embodiment, the first charge weld results in less wasted material than a second dummy block with a flat front end.

The following description and the drawings contain certain illustrative aspects of the specification. These aspects are indicative, however, of but a few of the various ways in which the principles of the specification may be employed. Other advantages and novel features of the specification will become apparent from the following detailed description of the specification when considered in conjunction with the drawings.

### BRIEF DESCRIPTION OF THE DRAWINGS

Numerous aspects, embodiments, objects and advantages of the present invention will be apparent upon consideration of the following detailed description, taken in conjunction with the accompanying drawings, in which like reference characters refer to like parts throughout, and in which:

FIG. 1 depicts a non-limiting schematic diagram of an exemplary extrusion device with a concave ogive shape according to various non-limiting aspects of the subject disclosure;

FIG. 2 depicts a non-limiting schematic diagram of an exemplary extrusion device with a concave ogive shape that generates a small charge weld according to various non-limiting aspects of the subject disclosure;

FIG. 3 depicts a non-limiting schematic diagram of an exemplary extrusion device with a concave ogive shape and a billet with curved ends according to various non-limiting aspects of the subject disclosure;

FIG. 4 depicts a non-limiting schematic diagram of an exemplary extrusion device with a convex ogive shape according to various non-limiting aspects of the subject disclosure;

FIG. 5 depicts a non-limiting schematic diagram of an exemplary extrusion device with a convex ogive shape that generates a strong charge weld according to various non-limiting aspects of the subject disclosure;

FIG. 6 depicts a non-limiting schematic diagram of an exemplary extrusion device with a convex ogive shape and a billet with curved ends according to various non-limiting aspects of the subject disclosure; and

FIG. 7 depicts an exemplary flowchart of non-limiting methods associated with extruding metal from an extrusion device with an ogive shaped dummy block according to various non-limiting aspects of the disclosed subject matter.

### DETAILED DESCRIPTION

### Overview

While a brief overview is provided, certain aspects of the subject disclosure are described or depicted herein for the purposes of illustration and not limitation. Thus, variations of the disclosed embodiments as suggested by the disclosed apparatuses, systems and methods are intended to be encompassed within the scope of the subject matter disclosed herein. For example, the various embodiments of the apparatuses, devices, techniques and methods of the subject disclosure are described in the context of extrusion devices. However, as further detailed below, various exemplary implementations can be applied to other areas of industrial manufacturing and services where material is extruded through a die and solid-state welds are formed between different billets of material or between extrudates. The embodiments disclosed herein can apply to extrusion of metals, metal alloys and light metal alloys, for example: aluminum, steel, magnesium and other commonly used metals in industry as well as ceramics, polymers, clays, concretes, and other materials without departing from the subject matter described herein.

Additionally, terms such as “at the same time,” “common time,” “simultaneous,” “simultaneously,” “concurrently,” “substantially simultaneously,” “immediate,” and the like are employed interchangeably throughout, unless context warrants particular distinctions among the terms. It should be appreciated that such terms can refer to times relative to each other and may not refer to an exactly simultaneously action(s).

Solid-state welds formed during consecutive billet on billet direct extrusion lead to high metal scrap rates and limited structural uses of the profiles. The areas around the solid-state welds, also known as bullet welds or charge welds, are typically removed from the extruded product because they can have uncertain mechanical properties due to a weak solid-state weld strength and/or contaminants the material including iron rich intermetallics and Mg₂Si precipitates that originate at the surface of the cast billet.

Various embodiments provide for an extrusion device with a dummy block or ram end (wherein dummy block and ram end can be synonymous where utilized herein) configured to change the shape and length of charge welds between extrudates originating from different billets in order to reduce the amount of scrap and waste material. In an embodiment, the dummy block, which forces the billet of material within an extrusion chamber through an opening in an extrusion die, can have a curved surface in contact with a back end of the billet of material. The ram end/dummy block facilitates the billet of material, as it is extruded through the die, to form a solid-state weld that is shorter than when pushed through the extrusion die by a dummy block having a flat surface in contact with the back end of the billet of material. The amount of wasted material can thus be reduced by reducing the length of extrudate that needs to be scrapped. In one or more embodiments, the dummy block can have a convex or concave curved surface such that the billet of material, as it is extruded through the die, forms a solid-state weld that is longer than a weld due to a flat faced dummy block. This longer weld can be stronger than the weld due to the flat faced dummy block, thus obviating the need to throw away a portion of the extrudate. It is to be appreciated that when the dummy blocks and billets are described as having convex or concave shaped surfaces, that in different embodiments, the front end surface of the dummy block and ends of the billets can be any form of curved shape including ogive shaped, parabolic, hyperbolic, semicircular, or other similar geometric shapes and can also include straight edged convex and concave shapes.

### Exemplary Embodiments

Various aspects or features of the subject disclosure are described with reference to the drawings, wherein like reference numerals are used to refer to like elements throughout. In this specification, numerous specific details are set forth in order to provide a thorough understanding of the subject disclosure. It should be understood, however, that the certain aspects of disclosure may be practiced without these specific details, or with other methods, components, parameters, etc. In other instances, well-known structures and devices are shown in block diagram form to facilitate description and illustration of the various embodiments.

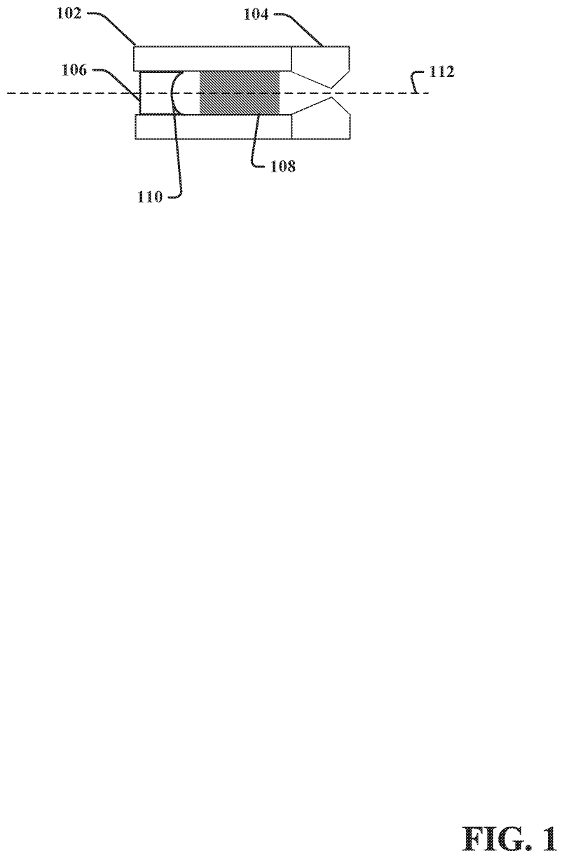

FIG. 1 illustrates an exemplary diagram 100 of an extrusion device with a concave curved surface 110 according to various non-limiting aspects of the subject disclosure. In some embodiments, the concave curved surface 110 can have a concave ogive shaped surface.

In the embodiment shown in FIG. 1, an extrusion chamber 102 and a die 104 are provided along with a dummy block 106 that forces a billet of material 108 (e.g., metal, metal alloy, light metal alloy, aluminum, magnesium, steel, or other material) through the die 104 in order to reduce the amount of wasted extrudate.

The dummy block can have a concave surface 110 such that the edges of the concave surface 110 of dummy block 106 are closer to the billet of material 108 than the center of the dummy block 106. In an embodiment, the dummy block can have a parabolic concave shape, semi-circle shape or ogive shape, or other concave curvature. In an embodiment, ogive-shaped can refer to a roundly tapered or pointed end of a three-dimensional object. As used herein, ogive can refer to a tangent ogive, secant ogive, or to a general oval and/or semicircle shape, or a curvature having a (rotated) cross-section that is defined by a suitable polynomial expression or other suitable function (e.g., first order circular cross-section, second order parabolic cross-section, third order cross-section, a combination of the foregoing or of additional orders, and so forth).

It is to be appreciated that FIG. 1 and the other figures are two dimensional representations of three dimensional objects, and as such, the figures depict slices, or cutaways of the extrusion device described here. Extrusion chamber 102 thus can have a cylindrical shape or a rectangular shape (or square), but have chamber walls that surround the chamber where the billet 108 is placed for extrusion. Similarly, the die 104 can have an opening that is circular, square, rectangular, or have any other geometry depending on the desired configuration of the extrudate. For example, extrusion chamber 102 and die 104 can be rotated solids formed by rotation of the depicted slices about a centerline axis 112 (or substantially centerline axis 112). In an embodiment, the billet 108 can be cylindrical or rectangular, or any other commonly used shape.

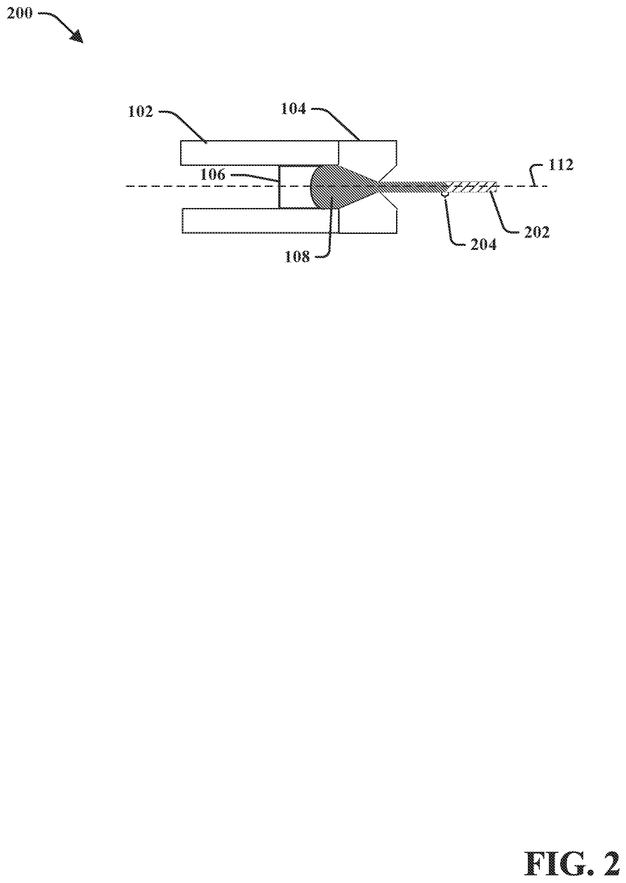

Turning now to FIG. 2, illustrated is a non-limiting schematic diagram 200 of an exemplary extrusion device with a concave ogive shape that generates a small charge weld according to various non-limiting aspects of the subject disclosure.

In the embodiment shown in FIG. 2, the dummy block 106 has been activated and the billet 108 is being extruded through the opening of the die 104. The extrudated material forms a transverse charge weld or solid-state weld 204 with extruded material 202 formed by a second billet (not depicted) that was previously extruded and in contact with billet 108. The transverse length of the weld 204 is much shorter than a regular charge weld formed by a flat faced dummy block, and so the amount of extruded material to be scrapped can be reduced.

In another embodiment, in order to reduce the length of the charge weld 204 to reduce the amount of scrap material, billet 108 can be of a softer material than the previously extruded billet. The level of softness can be regulated by adjusting the temperature of the billet material as it is being extruded. In another embodiment, a positive or negative telescoping dummy block could enable a flat faced dummy block extrusion to take place until the very end of the extrusion stroke during which the front surface of the dummy block could be adjusted to become concave or convex. In yet another embodiment, the rear end of the previously extruded material (end closest to the die 104) could be sheared into a convex shape so that the billet 108 as it is extruded would collide with the non-flat faced extruded material.

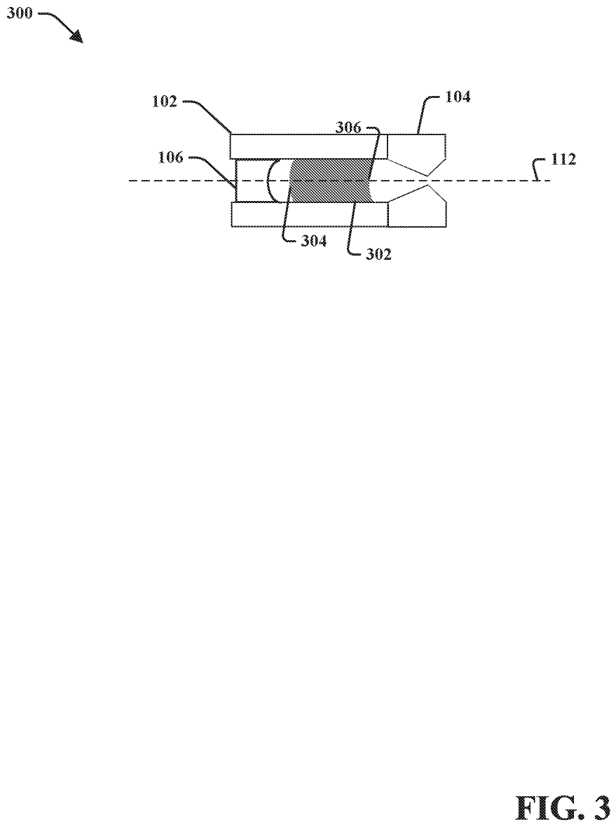

FIG. 3 shows a different embodiment 300 wherein the billet 302 can be shaped with curved surfaces at a rear surface 304 or front surface 306, or both, in order to effect a change to the transverse weld length by increasing the effect of shortening the transverse weld length for a similarly shaped dummy block 106. In an embodiment, the billet 302 can have a convex surface 304 facing (e.g., adjacent to) the dummy block 106 and a concave surface 306 facing (e.g., adjacent to) the die 104. A concave dummy block 106 may experience radial expansion as the recess fills with metal during forward extrusion. The depth of the concave cavity (or depth of the concave curvature) in the dummy block could be reduced, whilst retaining the desired shortening of weld length, by extruding non-flat face cylindrical billets 302.

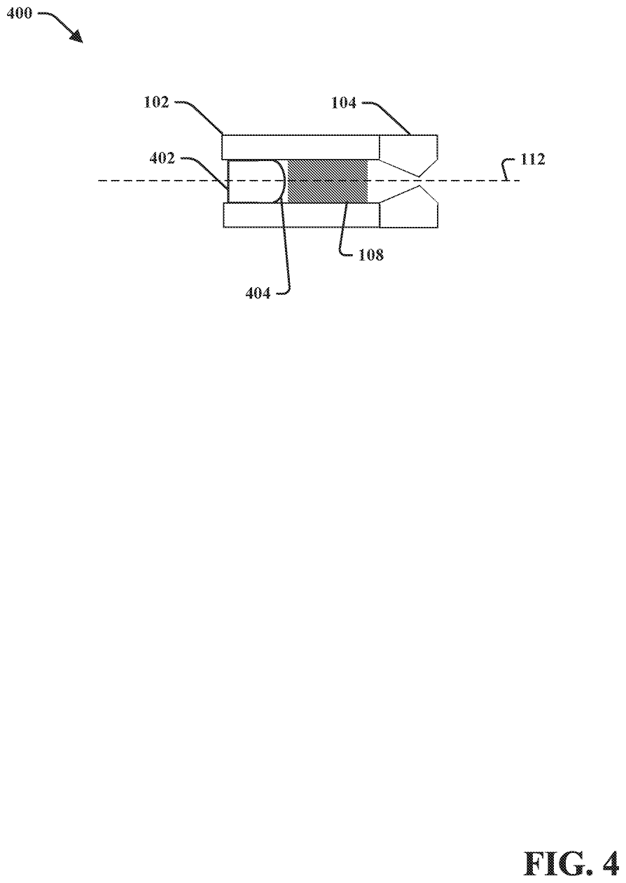

Turning now to FIG. 4, illustrated is a diagram 400 of an exemplary extrusion device with a convex curved surface according to various non-limiting aspects of the subject disclosure. In the embodiment shown in FIG. 4, an extrusion chamber 102 and a die 104 are provided along with a dummy block 402 that forces a billet of material 108 (e.g., metal, aluminum, magnesium, steel, a metal alloy, a light metal alloy, or other material) through the die 104 in order to reduce the amount of wasted extrudate.

The dummy block 402 can have a convex curved surface 404 adjacent to the billet of material 108 such that the center of the convex curved surface 404 of the dummy block 402 is closer to the billet 108 than the edges of the convex curved surface 404 of the dummy block 402. In an embodiment, the dummy block 402 can have a parabolic convex shape, semi-circle shape or ogive shape or other suitable convex curvature (e.g., a rotated cross-section defined by a suitable polynomial expression or other function). In an embodiment, ogive-shaped can refer to a roundly tapered or pointed end of a three-dimensional object. As used herein, ogive can refer to tangent or secant ogive shape, or to a general oval and/or semicircle shape, or a curvature having a (rotated) cross-section that is defined by a suitable polynomial expression or other suitable function (e.g., first order circular cross-section, second order parabolic cross-section, third order cross-section, a combination of the foregoing or of additional orders, and so forth).

It is to be appreciated that FIG. 4 and the other figures are two dimensional representations of three dimensional objects, and as such, the figures depict slices, or cutaways of the extrusion device described here. Extrusion chamber 102 thus can have a cylindrical shape or a rectangular shape (or square), but have chamber walls that surround the chamber where the billet 108 is placed for extrusion. Similarly, the die 104 can have an opening that is circular, square, rectangular, or have any other geometry depending on the desired configuration of the extrudate. For example, extrusion chamber 102 and die 104 can be rotated solids formed by rotation of the depicted slices about a centerline axis 112 (or substantially centerline axis 112). In an embodiment, the billet 108 can be cylindrical or rectangular, or any other commonly used shape.

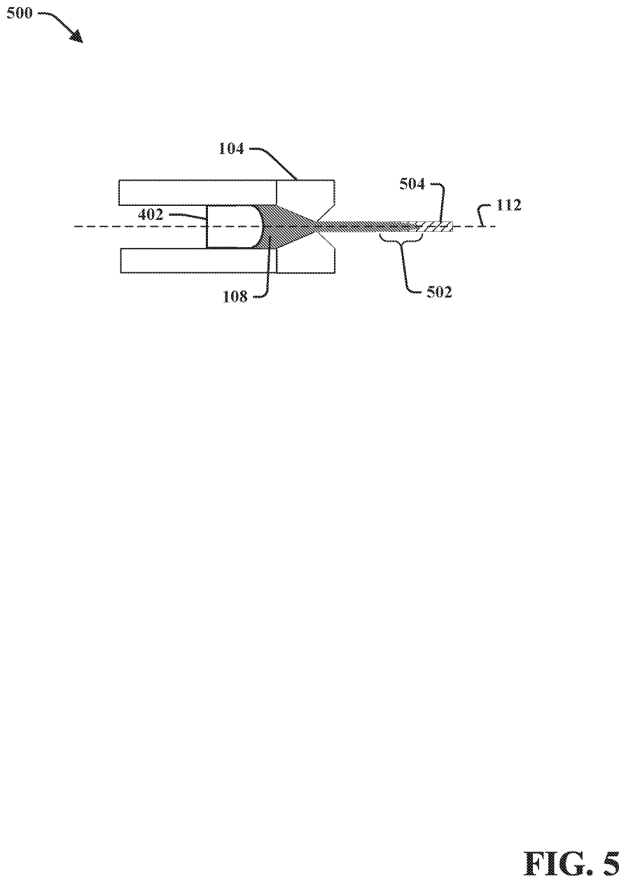

Turning now to FIG. 5, illustrated is a non-limiting schematic diagram 500 of an exemplary extrusion device with a convex ogive shape that generates a strong charge weld according to various non-limiting aspects of the subject disclosure.

In the embodiment shown in FIG. 5, the dummy block 402 is undergoing an extrusion stroke and the billet 108 is being extruded through the opening of the die 104. The extrudated material forms a transverse charge weld or solid-state weld 502 with extruded material 504 of a second billet (not depicted) in front of billet 108 and that was previously extruded prior to extrusion of billet 108 as depicted in the illustration of FIG. 5. The transverse length of the weld 502 is longer than a regular charge weld formed by a dummy block with a flat surface that contacts the billet, and by increasing the area over which the contaminants are spread, and by increasing the area of the weld surface, the weld 502 can be strong enough, or stronger than predetermined strength such that the extruded material around the weld does not have to be scrapped. Different shapes of dummy blocks with different convex shapes can be used to create different length of welds 502 with different strengths based on the requirements of the extruded materials.

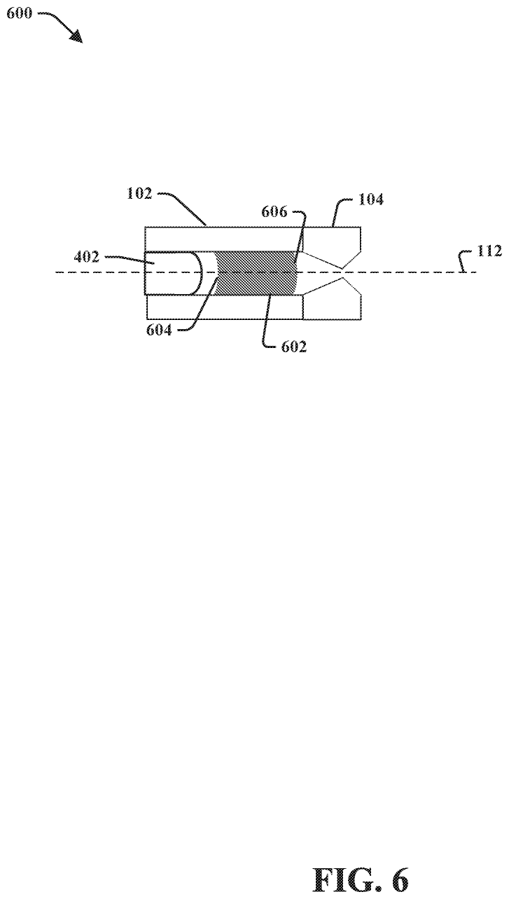

FIG. 6 shows a different embodiment 600 to that shown in FIG. 5, where the billet 602 can be shaped with curved surface in order to effect a change to the transverse weld length by increasing the effect of lengthening the transverse weld length for a similarly shaped dummy block 402. In an embodiment, the billet 602 can have a concave surface 604 facing (e.g., adjacent to) the dummy block 402 and a convex surface 606 facing (e.g., adjacent to) the die 104.

According to some disclosed embodiments, components of FIGS. 1 through 6 can be interchanged with components of other such Figures, as would be understood in the art or made known to one of ordinary skill in the art by way of the context provided herein. For instance, in some embodiments, a billet 602 of FIG. 6 can be substituted for billet 108 of FIG. 5, or other Figures herein. Other combinations, substitutions or modifications to the explicitly depicted Figures that would be understood by one of ordinary skill in the art by way of the context provided herein are within the scope of the present disclosure.

### Exemplary Methods

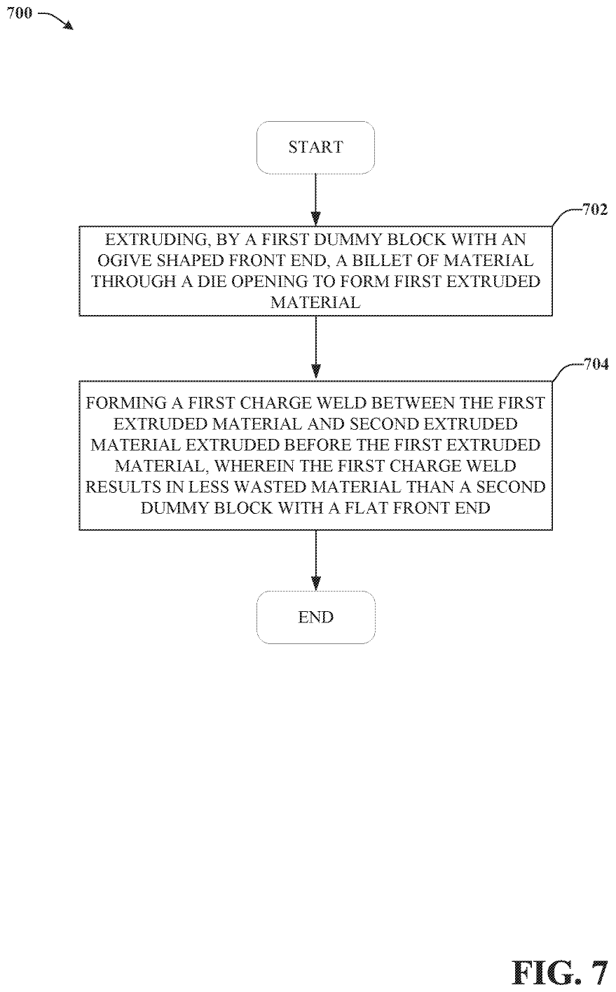

In view of the subject matter described supra, methods that can be implemented in accordance with the subject disclosure will be better appreciated with reference to the flowchart of FIG. 7. While for purposes of simplicity of explanation, the methods are shown and described as a series of blocks, it is to be understood and appreciated that such illustrations or corresponding descriptions are not limited by the order of the blocks, as some blocks may occur in different orders and/or concurrently with other blocks from what is depicted and described herein. Any non-sequential, or branched, flow illustrated via a flowchart should be understood to indicate that various other branches, flow paths, and orders of the blocks, can be implemented which achieve the same or a similar result. Moreover, not all illustrated blocks may be required to implement the methods described hereinafter.

FIG. 7 depicts an exemplary flowchart of non-limiting methods associated with extruding metal from an extrusion device with a ogive shaped dummy block according to various non-limiting aspects of the disclosed subject matter. The method 700 can start at 702 where the method includes extruding, by a first dummy block or ram end with an curved front surface, a billet of material through a die opening to form first extruded material. In an embodiment, the curved front surface can be a concave or convex curvature. In another embodiment, the curved front surface can be an ogive shaped concave or convex curvature. In still other embodiments, the billet of material can have a rear surface in contact with the curved front surface of the first dummy block, and a front surface. The rear surface or the front surface can be non-flat in one or more embodiments. For instance, the rear surface or the front surface can have a concave curvature, a convex curvature, different curvatures, the same curvature, or one can be curved while the other is flat.

At 704, the method includes forming a first charge weld between the first extruded material and second extruded material extruded before the first extruded material. In an embodiment, the first charge weld results in less wasted material than a second dummy block with a flat front surface.

In an embodiment, when the dummy block has a concave front surface, the charge weld formed between the first extruded material and the second extruded material is shorter in transverse length than the charge weld formed from a dummy block with the flat front surface—therefore, less of the material around the charge weld needs to be discarded. Alternatively, when the dummy block has a convex front surface, the charge weld's transverse length is increased, which can increase the overall strength of the weld such that no material needs to be scrapped, depending on the desired strength of the extruded material.

What has been described above includes examples of the embodiments of the present disclosure. It is, of course, not possible to describe every conceivable combination of components or methodologies for purposes of describing the claimed subject matter, but it is to be appreciated that many further combinations and permutations of the subject innovation are possible. Accordingly, the claimed subject matter is intended to embrace all such alterations, modifications, and variations that fall within the spirit and scope of the appended claims. Moreover, the above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize. Moreover, use of the term “an embodiment” or “one embodiment” throughout is not intended to mean the same embodiment unless specifically described as such.

In particular and in regard to the various functions performed by the above described components, devices, systems and the like, the terms used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as method instructions stored on a computer-readable storage medium having computer-executable instructions for performing the acts and/or events of the various methods of the claimed subject matter.

The aforementioned diagrams/devices have been described with respect to interaction between several components/blocks. It can be appreciated that such components/devices/blocks can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components. Any components described herein may also interact with one or more other components not specifically described herein but known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What is claimed is:

1. An extrusion device, comprising:
an extrusion chamber having an interior and an output surface;
a die with an opening configured to receive a billet of material from the interior of the extrusion chamber through the output surface of the extrusion chamber; and
a dummy block configured to push a first billet of material from the extrusion chamber through the output surface and the opening of the die resulting in first extruded material, wherein a surface of the dummy block that is in contact with the first billet of material is a curved surface.

2. The extrusion device of claim 1, wherein the surface of the dummy block is a parabolic curved surface, or an ogive curved surface.

3. The extrusion device of claim 1, wherein the extruded material forms a first charge weld with second extruded material from a second billet of material that was extruded before the first extruded material.

4. The extrusion device of claim 3, wherein the surface of the dummy block is convex curvature.

5. The extrusion device of claim 4, wherein the first charge weld between the first extruded material and the second extruded material is longer than a second charge weld from a second dummy block having a flat surface in contact with the first billet of material.

6. The extrusion device of claim 4, wherein the first charge weld between the first extruded material and the second extruded material is stronger than a second charge weld from a second dummy block having a flat surface in contact with the first billet of material.

7. The extrusion device of claim 4, wherein the first charge weld between the first extruded material and the second extruded material is stronger than a defined charge weld strength.

8. The extrusion device of claim 4, wherein the billet of material is a cylinder with a first surface in contact with the dummy block that is concave, and a second surface opposite the first surface that is convex.

9. The extrusion device of claim 3, wherein the surface of the dummy block is concave curvature.

10. The extrusion device of claim 9, wherein the first charge weld between the first extruded material and the second extruded material is shorter than a second charge weld from a second dummy block having a flat surface in contact with the first billet of material.

11. An extrusion apparatus, comprising:
a die with an opening through which a billet of material is received from an extrusion chamber and is extruded; and
a first dummy block configured to push the billet of material through the opening of the die resulting in first extruded material, wherein the first dummy block has a surface that is curved along an axis of motion of the dummy block.

12. The extrusion apparatus of claim 11, wherein a first charge weld between the first extruded material and second extruded material extruded before the first extruded material has a first length that is different than a second length of a second charge weld associated with a second dummy block with a flat surface along the axis of motion.

13. The extrusion apparatus of claim 11, wherein the first dummy block has a convex face.

14. The extrusion apparatus of claim 13, wherein the first charge weld between the first extruded material and the second extruded material is longer than the second charge weld.

15. The extrusion apparatus of claim 13, wherein the first charge weld between the first extruded material and the second extruded material is stronger than the second charge weld.

16. The extrusion apparatus of claim 13, wherein the billet of material is a cylinder with a first face closer to the dummy block, and a second face on the other end of the billet of material from the first face, wherein the first face is concave and the second face is convex.

17. The extrusion apparatus of claim 11, wherein the first dummy block has a concave face.

18. The extrusion apparatus of claim 17, wherein the first charge weld between the first extruded material and the second extruded material is shorter than a second charge weld from a flat shaped dummy block.

19. The extrusion apparatus of claim 17, wherein the billet of material is a cylinder with a first face closer to the dummy block, and a second face on the other end of the billet of material from the first face, wherein the first face is convex and the second face is concave.

20. A method, comprising:
extruding, by a first dummy block with an ogive shaped front end, a billet of material through a die opening to form first extruded material; and
forming a first charge weld between the first extruded material and second extruded material extruded before the first extruded material, wherein the first charge weld results in less wasted material than a second dummy block with a flat front end.
